(19) United States
(12) Patent Application Publication
(10) Pub. No.: US 2026/0010727 A1
(43) Pub. Date: Jan. 8, 2026

(54) INTERACTION METHOD, ELECTRONIC DEVICE, AND STORAGE MEDIUM

(71) Applicant: Beijing Baidu Netcom Science Technology Co., Ltd., Beijing (CN)

(72) Inventors: Yiqing WU, Beijing (CN); Jie LIAO, Beijing (CN); Shaoyun LV, Beijing (CN); Chunguang CHAI, Beijing (CN); Xiaopeng CUI, Beijing (CN); Liping OUYANG, Beijing (CN); Hong ZHU, Beijing (CN); Shuai YAO, Beijing (CN); Zizhan YU, Beijing (CN); Na ZHAO, Beijing (CN)

(21) Appl. No.: 19/326,314

(22) Filed: Sep. 11, 2025

(30) Foreign Application Priority Data
Jul. 29, 2025 (CN) 202511052927.4

(51) Int. Cl. G06F 40/30; G06F 16/332

(52) U.S. Cl. CPC G06F 40/30; G06F 16/3326

(57) ABSTRACT

An interaction method, an electronic device, and a storage medium are provided, which relate to the field of artificial intelligence technologies, and in particular to the fields such as deep learning, large models, and intelligent question answering. The interaction method includes: displaying a first corpus content in received corpus data; in response to an interaction operation performed by a target object on the first corpus content, updating the first corpus content and a second corpus content having a semantic dependency relationship with the first corpus content in the corpus data, to obtain target corpus data; and determining a feedback information related to a demand intention of the target object based on the target corpus data.

This application claims the benefit of priority to Chinese Patent Application No. 202511052927.4, filed on Jul. 29, 2025. The entire contents of this application are hereby incorporated herein by reference.

### TECHNICAL FIELD

The present disclosure relates to the field of artificial intelligence technologies, and in particular to the fields such as deep learning, large models, and intelligent question answering.

### BACKGROUND

Corpus data may include text content expressed in natural language. For example, the corpus data may be news articles, papers, or other text content related to a specified topic. The corpus data may also include structured information such as structured table content and chart content, so that users may quickly understand the information contained in the corpus data. Users may edit the corpus data through electronic devices such as smartphones and computers to obtain information that satisfies a demand intention.

### SUMMARY

The present disclosure provides an interaction method, an electronic device, and a storage medium.

According to an aspect of the present disclosure, an interaction method is provided, including: displaying a first corpus content in received corpus data; in response to an interaction operation performed by a target object on the first corpus content, updating the first corpus content and a second corpus content having a semantic dependency relationship with the first corpus content in the corpus data, to obtain target corpus data; and determining a feedback information related to a demand intention of the target object based on the target corpus data.

According to another aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to implement the method provided in embodiments of the present disclosure.

According to another aspect of the present disclosure, a non-transitory computer-readable storage medium having computer instructions therein is provided, and the computer instructions are configured to cause a computer to implement the method provided in embodiments of the present disclosure.

It should be understood that the content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute any limitation to the present disclosure. In the accompanying drawings:

FIG. 1 schematically shows an exemplary system architecture to which an interaction method and apparatus may be applied according to an embodiment of the present disclosure;

FIG. 2 schematically shows a flowchart of an interaction method according to an embodiment of the present disclosure;

FIG. 3 schematically shows an application scenario diagram of a method for generating corpus data based on a large model according to an embodiment of the present disclosure;

FIG. 4 schematically shows a flowchart of performing a corpus content generation task according to a context corpus content and an operation information of an interaction operation by using a designated large model, according to an embodiment of the present disclosure;

FIG. 5 schematically shows a block diagram of an interaction apparatus according to an embodiment of the present disclosure; and

FIG. 6 shows a schematic block diagram of an example electronic device that may be used to implement the interaction method according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In the technical solutions of the present disclosure, the acquisition, storage, and application of user personal information all comply with relevant laws and regulations, take necessary confidentiality measures, and do not violate public order and good customs.

The inventors have found that editing corpus content such as news articles, academic papers, and scripts often requires complex interaction operations. In particular, annotating corpus data for specific application scenarios such as large language model training requires relevant personnel to complete the annotation through complex interaction operations. The complexity of interaction operations often leads to errors in the generated corpus data, thus reducing the quality of the corpus data and making it difficult to satisfy practical requirements of specific scenarios such as language model training. Furthermore, the manner of interaction with corpus data may negatively affect an efficiency of corpus data generation, making it difficult to satisfy user requirements.

Embodiments of the present disclosure provide an interaction method, an interaction apparatus, an electronic device, a storage medium, and a program product. The interaction method includes: displaying a first corpus content in received corpus data; in response to an interaction operation performed by a target object on the first corpus content, updating the first corpus content and a second corpus content having a semantic dependency relationship with the first corpus content in the corpus data, to obtain target corpus data; and determining a feedback information related to a demand intention of the target object based on the target corpus data.

According to embodiments of the present disclosure, by updating the first corpus content and a second corpus content having a semantic dependency relationship with the first corpus content in the corpus data to be edited in response to an interaction operation performed by the target object on the first corpus content in the corpus data, the content in the corpus data that the target object intends to modify may be automatically and conveniently updated according to an editing intention for the corpus data as represented by the interaction operation of the target object, so as to satisfy user requirements for editing and modifying the corpus data and reduce the complexity of interaction operations for editing the corpus data. Furthermore, by automatically updating the content that the target object intends to modify, it is possible to avoid omissions in the corpus data editing process, then a quality of the corpus content in the feedback information may be improved, and an efficiency of updating the corpus data may be enhanced.

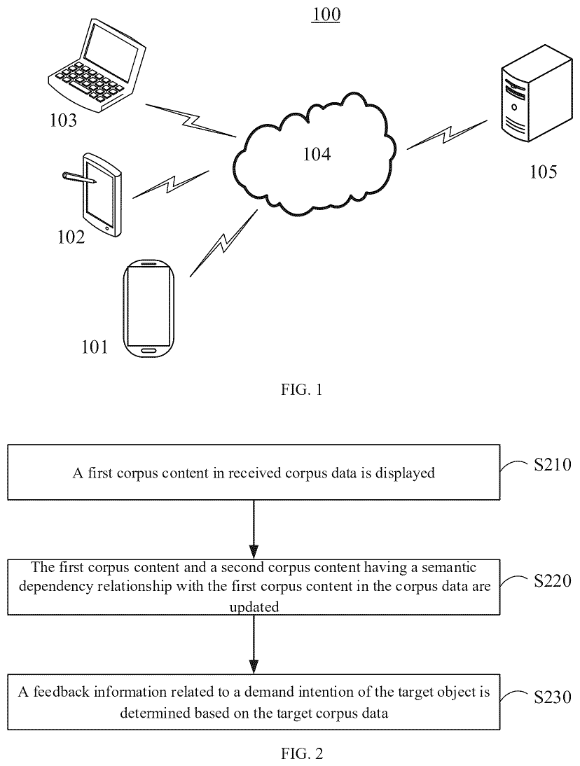

FIG. 1 schematically shows an exemplary system architecture to which an interaction method and apparatus may be applied according to an embodiment of the present disclosure.

As shown in FIG. 1, a system architecture 100 according to this embodiment may include a first terminal device 101, a second terminal device 102, a third terminal device 103, a network 104, and a server 105. The network 104 serves as a medium for providing communication links between the first terminal device 101, the second terminal device 102, the third terminal device 103, and the server 105. The network 104 may include various types of connections, such as wired and/or wireless communication links, and the like.

The first terminal device 101, the second terminal device 102, and the third terminal device 103 may be used by users to interact with the server 105 through the network 104 to receive or send messages, etc. Various communication client applications may be installed on the first terminal device 101, the second terminal device 102, and the third terminal device 103, such as knowledge reading applications, web browser applications, search applications, instant messaging tools, email clients, and/or social platform software (only for example).

The first terminal device 101, the second terminal device 102, and the third terminal device 103 may be various electronic devices having display screens and supporting web browsing, including but not limited to smartphones, tablet computers, laptop computers, and desktop computers, etc.

The server 105 may be a server that provides various services, such as a background management server (only for example) that provides support for the content browsed by users using the first terminal device 101, the second terminal device 102, and the third terminal device 103. The background management server may analyze and process data such as received user requests, and return processing results (such as web pages, information, or data acquired or generated according to user requests) to the terminal devices.

It should be noted that the interaction method provided by embodiments of the present disclosure may generally be performed by the first terminal device 101, the second terminal device 102, or the third terminal device 103. Accordingly, the interaction apparatus provided by embodiments of the present disclosure may be arranged in the first terminal device 101, the second terminal device 102, or the third terminal device 103.

Alternatively, the interaction method provided by embodiments of the present disclosure may generally be performed by the server 105. Accordingly, the interaction apparatus provided by embodiments of the present disclosure may generally be arranged in the server 105. The interaction method provided by embodiments of the present disclosure may also be performed by a server or server cluster that is different from the server 105 and capable of communicating with the first terminal device 101, the second terminal device 102, the third terminal device 103, and/or the server 105. Accordingly, the interaction apparatus provided by embodiments of the present disclosure may also be arranged in a server or server cluster that is different from the server 105 and capable of communicating with the first terminal device 101, the second terminal device 102, the third terminal device 103, and/or the server 105.

For example, a large model may be deployed in the server 105, or a large model may be deployed in a server or server cluster that is different from the server 105 and capable of communicating with the first terminal device 101, the second terminal device 102, the third terminal device 103, and/or the server 105.

It should be understood that the numbers of terminal devices, networks, and servers in FIG. 1 are merely schematic. Any number of terminal devices, networks, and servers may be provided according to implementation requirements. To facilitate the explanation of the interaction method of embodiments of the present disclosure, the server may be used as the execution subject of the method provided by embodiments of the present disclosure.

FIG. 2 schematically shows a flowchart of an interaction method according to an embodiment of the present disclosure.

As shown in FIG. 2, the interaction method includes operation S210 to operation S230.

In operation S210, a first corpus content in received corpus data is displayed.

In operation S220, in response to an interaction operation performed by a target object on the first corpus content, the first corpus content and a second corpus content having a semantic dependency relationship with the first corpus content in the corpus data are updated to obtain target corpus data.

In operation S230, a feedback information related to a demand intention of the target object is determined based on the target corpus data.

According to an embodiment of the present disclosure, the corpus data may include any type of natural language text data to be edited, such as news articles, academic papers, or scripts. The corpus data may include a plurality of corpus contents, which may be paragraphs or sentences of text in the corpus data. In some embodiments, the corpus content may be text content related to different topics in academic papers or work reports. The specific type of corpus content is not limited in embodiments of the present disclosure.

According to an embodiment of the present disclosure, the semantic dependency relationship between a plurality of corpus contents may indicate a degree of relevance of semantic attributes such as semantic similarity or semantic logical relationship between the plurality of corpus contents. For example, if a work report serves as the corpus data, the logistics report content, sales performance report content, and after-sales performance report content related to a Model A vehicle in the work report may have a semantic dependency relationship with “Model A vehicle”.

In some embodiments, the plurality of corpus contents in the corpus data may be displayed on an interaction interface of a computing device such as a smartphone or a computer. The interaction operation on the first corpus content may be any type of operation for editing the corpus content, such as text modification or format update, on text content such as paragraph content or sentence content in the first corpus content. For example, the interaction operation may be performed to modify a designated sentence in the abstract section content of the corpus data to obtain a new abstract section content. In response to the interaction operation on the abstract section content, an example section content and a conclusion section content that have a semantic dependency relationship with the modified sentence in the abstract section content may be modified, and an updated academic paper may be generated as the target corpus data.

In some embodiments, the semantic dependency relationship between the plurality of corpus contents in the corpus data may be determined based on the semantic similarity between the topics of the plurality of corpus contents. Alternatively, the semantic dependency relationship between the plurality of corpus contents may be constructed through manual annotation. For another example, the semantic dependency relationship between the plurality of corpus contents in the corpus data may be obtained by processing the plurality of corpus contents using a designated large model. The specific method for determining the semantic dependency relationship between the plurality of corpus contents is not limited in embodiments of the present disclosure.

In some embodiments, determining the feedback information based on the target corpus data may include pushing the target corpus data as feedback information to the target object.

In some embodiments, determining a feedback information related to the demand intention of the target object based on the target corpus data may further include: determining a target information pair based on the target corpus content in the target corpus data and an operation information of the interaction operation related to the target corpus content; and determining the feedback information based on the target information pair.

According to embodiments of the present disclosure, the target information pair may include the target corpus content, the operation information of the interaction operation related to the target corpus content, and a mapping relationship between the target corpus content and the operation information. Thus, the target information pair may represent an update intention of the target object and a modification result for the plurality of corpus contents in the corpus data, enabling relevant personnel in specific scenarios such as corpus data approval or report content modification to clearly understand the entire modification process, reducing omissions in the modification of corpus data in the feedback information, and improving an operational efficiency of relevant personnel for the target corpus data in specific scenarios.

In some embodiments, the feedback information may be used to train a language model to be trained. By understanding the target corpus data and the operation information of the interaction operation in the target information pair of the feedback information, the language model may learn negative examples that do not match the demand intention of the target object, as well as learn the interaction operation for the corpus content serving as such negative examples. Additionally, the language model may semantically understand the demand intention of the target object according to the target corpus data, thereby improving the model performance of the trained language model and enhancing the training efficiency of the language model.

It should be noted that the operation information of the interaction operation may include an information content of any type of interaction operation related to corpus content, such as information input, deletion, or format modification.

The language model or large model involved in embodiments of the present disclosure may be constructed based on a large language model (LLM). A large language model is a deep learning-based artificial intelligence model capable of understanding input demand information and generating text content that satisfies the user's demand intention.

In some embodiments, updating the first corpus content and a second corpus content having a semantic dependency relationship with the first corpus content in the corpus data may include: updating the first corpus content according to the interaction operation to obtain a first intermediate content; updating the second corpus content according to the first intermediate content and the semantic dependency relationship by using a designated large model to obtain a second intermediate content; and updating the corpus data by using the designated large model through semantic understanding of the first intermediate content and the second intermediate content to obtain the target corpus data.

In an example, a work report document may serve as the corpus data. The target object is allowed to modify the annual sales amount and sales volume of a Model A vehicle in the work report document, and the modified sales amount content constitutes the first intermediate content. The designated large model may process the first intermediate content and a plurality of corpus contents in the work report document based on the semantic dependency relationship, and modify warehousing and logistics costs related to sold vehicles and relevant information in a warehousing and logistics link of a vehicle logistics process report content in the work report document to obtain a second intermediate content. At the same time, the designated large model may modify relevant data such as the total annual sales amount and total profit across multiple vehicle models in the work report document. Thus, the second intermediate content obtained through automatic update may include both the modified warehousing and logistics costs of the vehicles and the relevant data such as the total annual sales amount and total profit across multiple vehicle models. By fusing the first intermediate content, the second intermediate content, and other corpus contents in the corpus data, the large model may generate an updated work report document as the target corpus data.

According to an embodiment of the present disclosure, by using the semantic dependency relationship as a prompt information, the designated large model may determine a second corpus content that meets a semantic dependency condition with the first corpus content from the plurality of corpus contents. For example, a semantic similarity between the second corpus content and the first corpus content may reach a predetermined similarity threshold. Through semantic understanding of a semantic difference between the first intermediate content and the first corpus content, the designated large model may determine the demand intention of the target object in performing the interaction operation to update the first corpus content. The second corpus content may then be updated based on the demand intention for updating the first corpus content, ensuring that the updated second intermediate content matches the demand intention of the target object. Furthermore, through semantic understanding of the first intermediate content and the second intermediate content, the designated large model may update content attributes of the corpus data, such as linguistic expression style and paragraph order of the corpus content in the corpus data, so that the plurality of corpus contents related to the interaction operation in the corpus data may be synchronously updated. By fusing a plurality of intermediate contents having a semantic dependency relationship using the designated large model, the target corpus data may maintain logical coherence and semantic integrity, so that the demand intention of the target object may be satisfied, and the data quality of the target corpus data may be improved.

In some embodiments, the semantic dependency relationship is determined through the following operation: performing semantic understanding on the plurality of corpus contents in the corpus data according to at least one of the first corpus content and the first intermediate content by using the designated large model, thereby obtaining the semantic dependency relationship.

In an embodiment, the designated large model may perform semantic understanding on the first intermediate content and the plurality of corpus contents, so that the designated large model may clearly understand a degree of semantic relevance between the updated first intermediate content and the plurality of corpus contents in the initial corpus data, and then a plurality of corpus contents having a high degree of semantic relevance with the updated first intermediate content may be determined as the second corpus content. In this way, based on the first intermediate content obtained from the interaction operation of the target object and the strong natural language understanding capability of the designated large model, the semantic dependency relationship may be determined accurately, and a plurality of corpus contents that the target object intends to update synchronously may be correctly understood, thereby avoiding errors in determining the semantic dependency relationship based on the interaction operation, which would otherwise degrade the quality of the target corpus data. As a result, the updated second intermediate content may accurately represent the actual demand intention of the target object, then the matching degree between the target corpus data and the demand intention of the target object may be improved, and the quality of the feedback information may be enhanced.

In an embodiment, the designated large model may perform semantic understanding on the first intermediate content, the first corpus content, and the plurality of corpus contents, so that the designated large model may clearly understand a semantic difference between the updated first intermediate content and the first corpus content, as well as a degree of semantic relevance between the first intermediate content and the plurality of corpus contents in the initial corpus data. As a result, the determined semantic dependency relationship may clearly indicate a degree of semantic relevance between the first corpus content and other corpus contents, as well as the content attributes of the corpus contents that need to be updated as indicated by the interaction operation of the target object. Accordingly, the corresponding second corpus content may be updated accurately based on the semantic dependency relationship, thereby avoiding omissions or errors in the update, improving the data quality of the target corpus data, and ensuring that the feedback information matches the actual interaction intention of the target object.

In some embodiments, the interaction method may further include: displaying a corpus content topology; and determining a sub-topology from the corpus content topology in response to a selection operation on the corpus content topology.

According to an embodiment of the present disclosure, the corpus content topology includes corpus node elements representing corpus contents and edge elements representing semantic dependency relationships between a plurality of corpus contents. The plurality of corpus node elements and edge elements in the corpus content topology may be displayed, so that the target object may clearly understand the semantic dependency relationship between the plurality of corpus contents based on the structured display manner of the corpus content topology.

In some embodiments, the target object is allowed to perform any type of selection operation on the corpus content topology, such as a box selection operation or a click operation, to select a plurality of corpus node elements and edge elements that meet the demand intention from the corpus content topology, thereby forming a sub-topology. Based on the plurality of corpus node elements and edge elements in the sub-topology, a distribution range of the second corpus content that needs to be synchronously modified with the first corpus content in the corpus data may be determined for the target object.

According to an embodiment of the present disclosure, the second corpus content is determined, based on the semantic dependency relationship, from corpus contents respectively corresponding to a plurality of candidate corpus node elements in the sub-topology. Thus, by selecting the distribution range of the second corpus content that needs to be synchronously updated with the first corpus content, the second corpus content may be synchronously updated according to the demand intention of the target object after the first corpus content is updated into the first intermediate content. In this way, a plurality of corpus contents in the corpus data that need to be updated for the target object may be accurately updated according to the interaction operation on the first corpus content, so that the frequency of interaction operations required from the target object may be reduced, and the efficiency of generating feedback information may be improved.

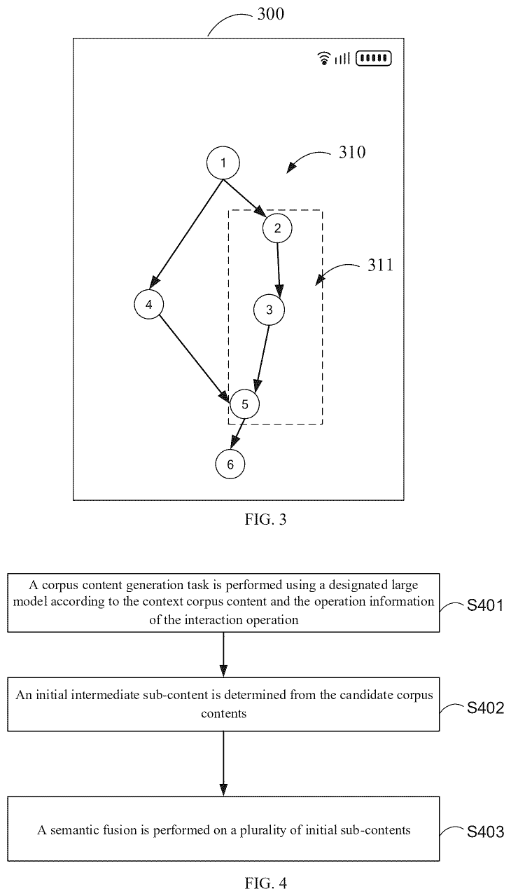

FIG. 3 schematically shows an application scenario diagram of a method for generating corpus data based on a large model according to an embodiment of the present disclosure.

As shown in FIG. 3, a corpus content topology 310 related to academic paper corpus data is displayed on a first interaction interface 300. The corpus content topology 310 may include a plurality of corpus node elements and edge elements. A first corpus node element may represent an abstract corpus content, a second corpus node element may represent a historical background research corpus content on Topic A, a third corpus node element may represent an introduction content of research content and viewpoints on Topic A, a fourth corpus node element may represent a detailed discussion content of research content and viewpoints, a fifth corpus node element may represent a corpus content of comparative discussion between the historical background research corpus content and the detailed discussion content of research content and viewpoints, and a sixth corpus node element may represent a suggestion corpus content of future research directions on Topic A.

The target object is allowed to perform a box selection operation on the second corpus node element, the third corpus node element, and the fourth corpus node element in the corpus content topology 310 to obtain a sub-topology 311. When the target object performs an interaction operation on the corpus content corresponding to the second node element, the corpus content corresponding to the third corpus node element and the corpus content corresponding to the fourth corpus node element may be determined as the second corpus contents, based on the semantic dependency relationship represented by the edge elements in the sub-topology 311, from the corpus contents respectively corresponding to the second corpus node element, the third corpus node element, and the fourth corpus node element. According to the operation information of the interaction operation, the historical background research corpus content on Topic A may be updated to obtain an updated first intermediate content. The designated large model may perform semantic understanding on the academic paper corpus data according to the updated first intermediate content, so as to update the second corpus contents respectively corresponding to the third corpus node element and the fourth corpus node element, thereby obtaining a second intermediate content. The designated large model may then perform a semantic fusion on the first intermediate content and the second intermediate content to obtain the target corpus data.

In an embodiment, the corpus data may be dialogue corpus data generated through a conversation among a plurality of role-based large models on a predetermined topic. The dialogue corpus data may include ten rounds of dialogue content, and the dialogue content may serve as the corpus content in the dialogue corpus data. The sub-topology determined by the target object based on the selection operation may represent, for example, dialogue contents from a second round to a fourth round in the conversation process. When an interaction operation is performed on the second-round dialogue content as the first corpus content, an updated second-round dialogue content may be determined. The designated large model may process the operation information of the interaction operation and the multi-round dialogue content in the dialogue corpus data, so as to perform a corpus content generation task by using the dialogue contents from a third round to a fourth round as the second corpus content, thereby obtaining updated dialogue contents from the third round to the fourth round as a second intermediate content. By fusing the first intermediate content and the second intermediate content using the designated large model, the target corpus data may be obtained. A feedback information may be determined based on the target corpus data and the interaction operation information related to the target corpus data.

In some embodiments, updating the first corpus content and the second corpus content having a semantic dependency relationship with the first corpus content in the corpus data may further include: performing a corpus content generation task according to a context corpus content and the operation information of the interaction operation by using the designated large model to obtain a target corpus content related to the first corpus content or the second corpus content; and determining the target corpus data according to the target corpus content.

According to an embodiment of the present disclosure, the operation information of the interaction operation may indicate a modification information for modifying the first corpus content. For example, the operation information may be a sentence added to the first corpus content. For another example, the operation information may represent a font change applied to the first corpus data. The context corpus content may be a corpus content in the corpus data that is semantically related to the first corpus content or the second corpus content.

For example, with respect to the first corpus content, when performing a corpus content generation task according to the context corpus content, the designated large model may leverage its strong semantic understanding capability to understand the semantic relevance between the context corpus content and the modification information indicated by the operation information. As a result, the generated first target corpus content may satisfy the actual requirement for modifying the first corpus content based on the modification information carried by the operation information of the target object, and also maintain logical coherence, semantic relevance, and corpus fluency with the context corpus content, thereby satisfying corpus quality requirements. Accordingly, the first target corpus content may remain logically coherent and semantically fluent with the context corpus content, further improving the data quality of the target corpus data.

For another example, the first target corpus content obtained by updating the first corpus content, together with other corpus contents in the corpus data, may serve as the context corpus content related to the second corpus content. By processing the context corpus content and the operation information, the designated large model may perform a corpus content generation task on the second corpus content, thereby obtaining the second target corpus content updated from the second corpus content. The updated second target corpus content may maintain logical coherence, semantic relevance, and corpus fluency with the corresponding context corpus content, thus satisfying corpus quality requirements. Thus, determining the target corpus data based on the first target corpus content and the second target corpus content may further improve the corpus quality, avoid degradation of semantic logic and linguistic fluency of other second corpus contents caused by interaction operation errors such as typing mistakes during the interaction operation of the target object, and reduce reliance on the interaction operation of the target object for updating corpus content, thereby improving user experience.

In some embodiments, the context corpus content related to the first corpus content or the second corpus content may be determined from the corpus data based on the semantic dependency relationship. Alternatively, the context corpus content related to the first corpus content or the second corpus content may be determined based on an interaction operation performed by the target object on a plurality of corpus contents in the corpus data.

In an embodiment, the context corpus content related to the first corpus content or the second corpus content may include all corpus contents in the corpus data other than the first corpus content or the second corpus content.

FIG. 4 schematically shows a flowchart of performing a corpus content generation task according to a context corpus content and an operation information of an interaction operation by using a designated large model, according to an embodiment of the present disclosure.

As shown in FIG. 4, performing a corpus content generation task according to a context corpus content and an operation information of an interaction operation by using a designated large model includes operation S401 to operation S403.

In operation S401, a corpus content generation task is performed using a designated large model according to the context corpus content and the operation information of the interaction operation, to obtain a plurality of candidate corpus contents.

In operation S402, in response to a target operation on a sub-content in the candidate corpus contents, an initial intermediate sub-content is determined from the candidate corpus contents.

In operation S403, a semantic fusion is performed on a plurality of initial sub-contents to obtain a target corpus content.

In some embodiments, a plurality of designated large models may be provided, each performing a corpus content generation task and outputting a corresponding candidate corpus content. As a result, a plurality of candidate corpus contents may be provided to the target object performing the interaction operation, thus offering rich corpus contents for selection. This avoids the situation in which the corpus content generated by a single large model fails to satisfy the actual update requirements of the target object, leading to repeated executions of the corpus content generation task by the large model. Accordingly, the efficiency of determining the target corpus content may be improved.

In some embodiments, the sub-content may be a portion of the candidate corpus content. For example, if the candidate corpus content is a paragraph of text, the sub-content may be a sentence within the paragraph. The target object may perform any type of target operation, such as a box selection operation, to determine the initial intermediate sub-content to be adopted from the candidate corpus contents. The initial intermediate sub-content may be understood as a sub-content such as sentences or keywords that satisfy the quality requirements and the update intention of the target object.

According to an embodiment of the present disclosure, a plurality of initial sub-contents may be concatenated to determine the target corpus content. Alternatively, a large language model may perform semantic understanding on the plurality of initial sub-contents and one or more corpus contents in the corpus data serving as context, thereby generating target corpus content that satisfies the quality and demand requirements. In this way, the semantic understanding capability of the large language model may ensure that the target corpus content maintains semantic logical coherence and linguistic fluency, and also ensure semantic consistency and coherence between the target corpus content and other sentences in the target corpus data. Thus, by leveraging language generation capabilities of different designated large models, the data quality of the target corpus data and the data quality of the feedback information may be improved.

In some embodiments, the target object is allowed to perform a selection operation on predefined model names, model versions, or model description information of a plurality of designated large models to determine a plurality of designated large models used to perform corpus content generation tasks.

In some embodiments, the corpus content generation task includes at least one tool invocation task. The designated large model may invoke a target tool to perform a designated task by executing the tool invocation task, thereby obtaining an intermediate result used for generating candidate corpus content or target corpus content.

According to an embodiment of the present disclosure, the target tool may be a tool resource configured with specific task execution functions. For example, the tool resource may include an information search engine, a code execution tool, an image recognition tool, or the like. The designated large model may invoke a target tool by performing a tool invocation task, and the target tool may perform a designated task according to tool invocation parameters output by the designated large model. A tool invocation execution result obtained from the tool resource performing the designated task may serve as the intermediate result.

The tool resource may include, for example, a document retrieval tool, a web search tool, an image processing tool, a language translation tool, or the like.

Specifically, a document retrieval tool may perform information extraction such as document summarization and question answering, perform a database query task, and parse a query result. A web search tool may search web pages and acquire relevant page content. A code execution and debugging tool may run program scripts in a designated language and return program script execution results. An image processing tool may understand image content and provide question answering, or generate images from natural language. Additional tools may include optical character recognition and extraction tools, language translation tools, multimodal data fusion tools, or the like.

In an embodiment, determining a feedback information related to the demand intention of the target object based on the target corpus data may include: determining the feedback information based on the target corpus data and a task description information of the tool invocation task related to the target corpus data.

In some embodiments, the task description information related to the tool invocation task includes a tool-task-related information of the tool invocation task. The tool-task-related information may include a tool description information of the invoked target tool, a task execution parameter of the tool invocation task, and the like. The tool-task-related information may be represented in a structured form so that the task description information may meet the actual needs for feedback information in specific scenarios.

For another example, the task description information related to the tool invocation task may further include: a name field and version identifier of the target tool, a target tool invocation parameter template, a result validation rule for the intermediate result output by the target tool, a timeout and retry strategy required for invoking the target tool to perform the designated task, an execution condition for invoking the target tool to perform the designated task, and the like.

According to an embodiment of the present disclosure, since the designated large model may specify the corpus content generation task based on reasoning processes such as chain-of-thought or tree-of-thought, the corpus content generation task may include a plurality of target tasks linked by dependency relationships, and the target tasks may include a tool invocation task. A subsequent target task that has a dependency relationship with the tool invocation task may take an execution result of the tool invocation task as an intermediate result, and the intermediate result may be input into the designated large model to perform the subsequent target task, until the plurality of target tasks are completed based on the dependency relationships, thereby obtaining the candidate corpus content or target corpus content. Because the feedback information includes the task description information related to the tool invocation task, the target corpus content in the feedback information and the task description information related to the tool invocation task may prompt the language model to be trained to learn a tool description information, a tool parameter range, and an intermediate result example in the task description information, thereby accurately acquiring a model capability of performing a content generation task by invoking tool resources. Thus, the feedback information may be adapted to scenarios of training and testing language models, thereby improving the quality of the target corpus data.

In an embodiment, the interaction method provided by embodiments of the present disclosure may be performed based on a corpus data annotation platform. A schematic description of the corpus data annotation platform in this embodiment is provided below.

The corpus data annotation platform includes a dialogue structure editing module, a version management module, a content validation module, and a verification and export module.

The dialogue structure editing module is configured to edit multi-turn dialogue content used as corpus data. It supports content editing across multiple rounds of dialogue or across multiple paragraphs in the same round of dialogue. During a conversation in which a plurality of role-based large models generate dialogue on a predetermined topic, when a dialogue flow has not yet been completed, the dialogue content output by the role-based large models during the conversation may be edited. The dialogue structure editing module is further configured to provide interaction operation elements. For example, up/down arrows, insertion marks, delete buttons, and other interaction operation elements for the corpus data may be provided, so that annotators may perform structured editing operations at any position. After an interaction operation is performed on the multi-turn dialogue, it is possible to update only the second corpus content having a semantic dependency relationship, without clearing other dialogue contents. During the editing process, each dialogue content is automatically saved as a draft at any time, but only saved formally when the user clicks the “submit” interaction element, thereby ensuring continuity of the annotator's editing of the dialogue content and data security.

The version management module is configured to perform an incremental storage function of storing a target corpus content obtained after each update by using a difference algorithm. For example, a difference calculation may be performed between the dialogue content of version V1 and the dialogue content of version V1.1, and only a difference content obtained from the difference calculation is written, thus avoiding redundant writing of full data and improving storage and retrieval efficiency. The version management module is further configured to perform a multi-version rollback function of enabling rollback to any historical version of corpus content at any time through a patch chain, and supporting export of historical versions as complete corpus data, thereby facilitating approvers in performing version comparison and recovery. The version management module is further configured to perform a permission and collaboration function of supporting a multi-user collaborative editing and approval workflow. The operator, timestamp, and modification summary are recorded in each round of modification, and operations such as “approve”, “reject”, or “secondary edit” may be performed during the approval process.

The content validation module is configured to check the structural integrity, semantic coherence, format, and length of the target corpus data. The structural integrity may involve automatically checking whether any dialogue content in the document lacks a paired user question/answer or model reply, and prompting, for example, “reply missing in round N”. The semantic coherence may involve, for example, scoring topic consistency between adjacent dialogue contents based on a lightweight semantic embedding model. If the score is below a threshold, a warning of “possible semantic jump” may be issued in a sidebar of the interaction interface, and a specific keyword difference may be displayed. The format and length validation may involve checking a character count in each paragraph, a paragraph count, and a use of special symbols in the dialogue content to ensure compliance with required conditions.

An instant feedback and actionable suggestion function is further provided. A validation result may be displayed on a left side of each paragraph in the form of “traffic light”, where green indicates no abnormalities, yellow indicates a minor warning to suggest the annotator to check, and red indicates a serious error to suggest the annotator to correct. Clicking the warning icon expands a list of detailed issues and provides a “one-click fix” button, for example, “auto-complete placeholder for missing reply” or “auto-complete required parameters for tool invocation example”.

FIG. 5 schematically shows a block diagram of an interaction apparatus according to an embodiment of the present disclosure.

As shown in FIG. 5, an interaction apparatus 500 includes a display module 510, a target corpus data obtaining module 520, and a feedback information determination module 530.

The first display module 510 is configured to display a first corpus content in received corpus data.

The target corpus data obtaining module 520 is configured to, in response to an interaction operation performed by a target object on the first corpus content, update the first corpus content and a second corpus content having a semantic dependency relationship with the first corpus content in the corpus data to obtain target corpus data.

The feedback information determination module 530 is configured to determine a feedback information related to a demand intention of the target object based on the target corpus data.

According to an embodiment of the present disclosure, the target corpus data obtaining module includes a first obtaining unit, a second obtaining unit, and a target corpus data obtaining unit.

The first obtaining unit is configured to update the first corpus content according to the interaction operation to obtain a first intermediate content.

The second obtaining unit is configured to update the second corpus content according to the first intermediate content and the semantic dependency relationship by using a designated large model to obtain a second intermediate content.

The target corpus data obtaining unit is configured to update the corpus data by using the designated large model through semantic understanding of the first intermediate content and the second intermediate content, to obtain the target corpus data.

According to an embodiment of the present disclosure, the interaction apparatus further includes a second display module and a sub-topology determination module.

The second display module is configured to display a corpus content topology, where the corpus content topology includes corpus node elements representing corpus contents and edge elements representing semantic dependency relationships between a plurality of corpus contents.

The sub-topology determination module is configured to, in response to a selection operation on the corpus content topology, determine a sub-topology from the corpus content topology, where the second corpus content is determined based on the semantic dependency relationship from corpus contents respectively corresponding to a plurality of candidate corpus node elements in the sub-topology.

According to an embodiment of the present disclosure, the semantic dependency relationship is determined by: performing semantic understanding on a plurality of corpus contents in the corpus data according to at least one of the first corpus content and the first intermediate content by using the designated large model, so as to obtain the semantic dependency relationship.

According to an embodiment of the present disclosure, the target corpus data obtaining module includes a target corpus content determination unit and a target corpus data determination unit.

The target corpus content determination unit is configured to perform a corpus content generation task according to a context corpus content and an operation information of the interaction operation by using a designated large model, to obtain a target corpus content related to the first corpus content or the second corpus content, where the context corpus content is semantically related to the first corpus content or the second corpus content, and the corpus data includes the context corpus content.

The target corpus data determination unit is configured to determine the target corpus data according to the target corpus content.

According to an embodiment of the present disclosure, the target corpus content determination unit includes a candidate corpus content obtaining sub-unit, an initial intermediate sub-content obtaining sub-unit, and a target corpus content obtaining sub-unit.

The candidate corpus content obtaining sub-unit is configured to perform a corpus content generation task according to the context corpus content and the operation information of the interaction operation by using the designated large model to obtain a plurality of candidate corpus contents.

The initial intermediate sub-content obtaining sub-unit is configured to, in response to a target operation on a sub-content in the candidate corpus contents, determine an initial intermediate sub-content from the candidate corpus contents.

The target corpus content obtaining sub-unit is configured to perform a semantic fusion on a plurality of initial sub-contents to obtain the target corpus content.

According to an embodiment of the present disclosure, the corpus content generation task includes at least one tool invocation task, and the designated large model is allowed to invoke a target tool to perform a designated task by performing the tool invocation task to obtain an intermediate result for generating the candidate corpus content or the target corpus content, where the feedback information determination module includes a first determination unit.

The first determination unit is configured to determine the feedback information based on the target corpus data and a task description information of the tool invocation task related to the target corpus data.

According to an embodiment of the present disclosure, the feedback information determination module includes a second determination unit and a third determination unit.

The second determination unit is configured to determine a target information pair based on a target corpus content in the target corpus data and an operation information of the interaction operation related to the target corpus content.

The third determination unit is configured to determine the feedback information based on the target information pair.

According to an embodiment of the present disclosure, the present disclosure further provides an electronic device, a readable storage medium, and a computer program product.

According to an embodiment of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to implement the method described above.

According to an embodiment of the present disclosure, a non-transitory computer-readable storage medium having computer instructions therein is provided, and the computer instructions are configured to cause a computer to implement the method described above.

According to an embodiment of the present disclosure, a computer program product containing a computer program is provided, and the computer program is configured to, when executed by a processor, implement the method described above.

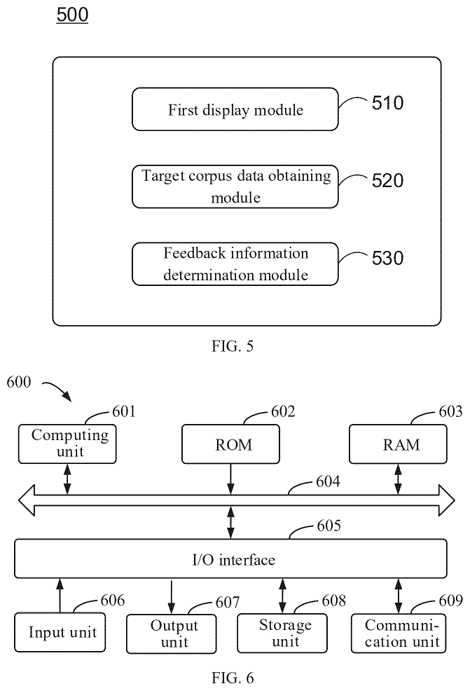

FIG. 6 shows a schematic block diagram of an example electronic device that may be used to implement the interaction method according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 6, the electronic device 600 includes a computing unit 601 which may perform various appropriate actions and processes according to a computer program stored in a read only memory (ROM) 602 or a computer program loaded from a storage unit 608 into a random access memory (RAM) 603. In the RAM 603, various programs and data necessary for an operation of the electronic device 600 may also be stored. The computing unit 601, the ROM 602 and the RAM 603 are connected to each other through a bus 604. An input/output (I/O) interface 605 is also connected to the bus 604.

A plurality of components in the electronic device 600 are connected to the I/O interface 605, including: an input unit 606, such as a keyboard, or a mouse; an output unit 607, such as displays or speakers of various types; a storage unit 608, such as a disk, or an optical disc; and a communication unit 609, such as a network card, a modem, or a wireless communication transceiver. The communication unit 609 allows the electronic device 600 to exchange information/data with other devices through a computer network such as Internet and/or various telecommunication networks.

The computing unit 601 may be various general-purpose and/or dedicated processing assemblies having processing and computing capabilities. Some examples of the computing units 601 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 601 executes various methods and processes described above, such as the interaction method. For example, in some embodiments, the interaction method may be implemented as a computer software program which is tangibly embodied in a machine-readable medium, such as the storage unit 608. In some embodiments, the computer program may be partially or entirely loaded and/or installed in the electronic device 600 via the ROM 602 and/or the communication unit 609. The computer program, when loaded in the RAM 603 and executed by the computing unit 601, may execute one or more steps in the interaction method described above. Alternatively, in other embodiments, the computing unit 601 may be used to perform the interaction method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the interaction method of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. An interaction method, comprising:
displaying a first corpus content in received corpus data;
in response to an interaction operation performed by a target object on the first corpus content, updating the first corpus content and a second corpus content having a semantic dependency relationship with the first corpus content in the corpus data, to obtain target corpus data; and
determining a feedback information related to a demand intention of the target object based on the target corpus data.

2. The method of claim 1, wherein the updating the first corpus content and a second corpus content having a semantic dependency relationship with the first corpus content in the corpus data to obtain target corpus data comprises:
updating the first corpus content according to the interaction operation to obtain a first intermediate content;
updating the second corpus content according to the first intermediate content and the semantic dependency relationship by using a designated large model, to obtain a second intermediate content; and
updating the corpus data by using the designated large model through semantic understanding of the first intermediate content and the second intermediate content, to obtain the target corpus data.

3. The method of claim 1, further comprising:
displaying a corpus content topology, wherein the corpus content topology comprises corpus node elements representing corpus contents and edge elements representing semantic dependency relationships among a plurality of corpus contents; and
in response to a selection operation on the corpus content topology, determining a sub-topology from the corpus content topology, wherein the second corpus content is determined based on the semantic dependency relationship from corpus contents respectively corresponding to a plurality of candidate corpus node elements in the sub-topology.

4. The method of claim 2, further comprising:
displaying a corpus content topology, wherein the corpus content topology comprises corpus node elements representing corpus contents and edge elements representing semantic dependency relationships among a plurality of corpus contents; and
in response to a selection operation on the corpus content topology, determining a sub-topology from the corpus content topology, wherein the second corpus content is determined based on the semantic dependency relationship from corpus contents respectively corresponding to a plurality of candidate corpus node elements in the sub-topology.

5. The method of claim 2, wherein the semantic dependency relationship is determined by:
performing semantic understanding on a plurality of corpus contents in the corpus data according to at least one of the first corpus content and the first intermediate content by using the designated large model, so as to obtain the semantic dependency relationship.

6. The method of claim 1, wherein the updating the first corpus content and a second corpus content having a semantic dependency relationship with the first corpus content in the corpus data to obtain target corpus data comprises:
performing a corpus content generation task according to a context corpus content and an operation information of the interaction operation by using a designated large model, to obtain a target corpus content related to the first corpus content or the second corpus content, wherein the context corpus content is semantically related to the first corpus content or the second corpus content, and the corpus data comprises the context corpus content; and
determining the target corpus data according to the target corpus content.

7. The method of claim 6, wherein the performing a corpus content generation task according to a context corpus content and an operation information of the interaction operation by using a designated large model comprises:
performing the corpus content generation task according to the context corpus content and the operation information of the interaction operation by using the designated large model to obtain a plurality of candidate corpus contents;
in response to a target operation on a sub-content in the candidate corpus contents, determining an initial intermediate sub-content from the candidate corpus contents; and
performing a semantic fusion on a plurality of initial intermediate sub-contents to obtain the target corpus content.

8. The method of claim 6, wherein the corpus content generation task comprises at least one tool invocation task, and the designated large model is allowed to invoke a target tool to perform a designated task by performing the tool invocation task to obtain an intermediate result for generating the candidate corpus content or the target corpus content;
wherein the determining a feedback information related to a demand intention of the target object based on the target corpus data comprises:
determining the feedback information based on the target corpus data and a task description information of the tool invocation task related to the target corpus data.

9. The method of claim 7, wherein the corpus content generation task comprises at least one tool invocation task, and the designated large model is allowed to invoke a target tool to perform a designated task by performing the tool invocation task to obtain an intermediate result for generating the candidate corpus content or the target corpus content;
wherein the determining a feedback information related to a demand intention of the target object based on the target corpus data comprises:
determining the feedback information based on the target corpus data and a task description information of the tool invocation task related to the target corpus data.

10. The method of claim 1, wherein the determining a feedback information related to a demand intention of the target object based on the target corpus data comprises:
determining a target information pair based on a target corpus content in the target corpus data and an operation information of the interaction operation related to the target corpus content; and
determining the feedback information based on the target information pair.

11. An electronic device, comprising:
at least one processor; and
a memory communicatively connected to the at least one processor,
wherein the memory stores instructions executable by the at least one processor, and the instructions are configured to, when executed by the at least one processor, cause the at least one processor to:
display a first corpus content in received corpus data;
in response to an interaction operation performed by a target object on the first corpus content, update the first corpus content and a second corpus content having a semantic dependency relationship with the first corpus content in the corpus data, to obtain target corpus data; and
determine a feedback information related to a demand intention of the target object based on the target corpus data.

12. The electronic device of claim 11, wherein the at least one processor is further configured to:
update the first corpus content according to the interaction operation to obtain a first intermediate content;
update the second corpus content according to the first intermediate content and the semantic dependency relationship by using a designated large model, to obtain a second intermediate content; and
update the corpus data by using the designated large model through semantic understanding of the first intermediate content and the second intermediate content, to obtain the target corpus data.

13. The electronic device of claim 11, wherein the at least one processor is further configured to:
display a corpus content topology, wherein the corpus content topology comprises corpus node elements representing corpus contents and edge elements representing semantic dependency relationships among a plurality of corpus contents; and
in response to a selection operation on the corpus content topology, determine a sub-topology from the corpus content topology, wherein the second corpus content is determined based on the semantic dependency relationship from corpus contents respectively corresponding to a plurality of candidate corpus node elements in the sub-topology.

14. The electronic device of claim 12, wherein the at least one processor is further configured to:
display a corpus content topology, wherein the corpus content topology comprises corpus node elements representing corpus contents and edge elements representing semantic dependency relationships among a plurality of corpus contents; and
in response to a selection operation on the corpus content topology, determine a sub-topology from the corpus content topology, wherein the second corpus content is determined based on the semantic dependency relationship from corpus contents respectively corresponding to a plurality of candidate corpus node elements in the sub-topology.

15. The electronic device of claim 12, wherein the at least one processor is further configured to:
perform semantic understanding on a plurality of corpus contents in the corpus data according to at least one of the first corpus content and the first intermediate content by using the designated large model, so as to obtain the semantic dependency relationship.

16. A non-transitory computer-readable storage medium having computer instructions therein, wherein the computer instructions are configured to cause a computer to:
display a first corpus content in received corpus data;
in response to an interaction operation performed by a target object on the first corpus content, update the first corpus content and a second corpus content having a semantic dependency relationship with the first corpus content in the corpus data, to obtain target corpus data; and
determine a feedback information related to a demand intention of the target object based on the target corpus data.

17. The storage medium of claim 16, wherein the computer instructions are further configured to cause the computer to:
update the first corpus content according to the interaction operation to obtain a first intermediate content;
update the second corpus content according to the first intermediate content and the semantic dependency relationship by using a designated large model, to obtain a second intermediate content; and
update the corpus data by using the designated large model through semantic understanding of the first intermediate content and the second intermediate content, to obtain the target corpus data.

18. The storage medium of claim 16, wherein the computer instructions are further configured to cause the computer to:
display a corpus content topology, wherein the corpus content topology comprises corpus node elements representing corpus contents and edge elements representing semantic dependency relationships among a plurality of corpus contents; and
in response to a selection operation on the corpus content topology, determine a sub-topology from the corpus content topology, wherein the second corpus content is determined based on the semantic dependency relationship from corpus contents respectively corresponding to a plurality of candidate corpus node elements in the sub-topology.

19. The storage medium of claim 17, wherein the computer instructions are further configured to cause the computer to:
display a corpus content topology, wherein the corpus content topology comprises corpus node elements representing corpus contents and edge elements representing semantic dependency relationships among a plurality of corpus contents; and
in response to a selection operation on the corpus content topology, determine a sub-topology from the corpus content topology, wherein the second corpus content is determined based on the semantic dependency relationship from corpus contents respectively corresponding to a plurality of candidate corpus node elements in the sub-topology.

20. The storage medium of claim 17, wherein the computer instructions are further configured to cause the computer to:
perform semantic understanding on a plurality of corpus contents in the corpus data according to at least one of the first corpus content and the first intermediate content by using the designated large model, so as to obtain the semantic dependency relationship.
